(19) United States
(12) Patent Application Publication
(10) Pub. No.: US 2005/0023068 A1
(43) Pub. Date: Feb. 3, 2005

(54) Portable hand control system for a vehicle

(76) Inventor: Bruce Ahnafield, Indianapolis, IN (US)

Correspondence Address: MAGINOT, MOORE & BECK;BANK ONE CENTER/TOWER, 1111 MONUMENT CIRCLE, INDIANAPOLIS, IN, 46204, US

(21) Appl. No.: 10/903,441

(22) Filed: Jul. 30, 2004

Related U.S. Application Data
(60) Provisional application No. 60/491,798, filed on Aug. 1, 2003.

(51) Int. Cl. B60K 26/00

(52) U.S. Cl. 180/315

(57) ABSTRACT

A portable vehicle control system for use by physically challenged drivers includes a pair of control rods that can be operated by the driver to directly depress the brake and accelerator pedals of a vehicle. The control rods include telescoping shafts that can be releasably locked at a length that is comfortable for the driver. The control rods are engaged to the vehicle pedals by way of a releasable strap with an attachment eye for receiving a hook at the end of the lowermost one of the telescoping shafts. The attachment eye extends from a pressure plate that facilitates even application of pressure to the vehicle pedal. A linking member links the upper end of the two control rods to form a stable construct while allowing each control rod to be independently manipulated.

### CROSS-REFERENCE TO RELATED APPLICATION

This application claims priority to co-pending provisional application No. 60/491,798, filed on Aug. 1, 2003, the disclosure of which is incorporated herein by reference.

### BACKGROUND OF THE INVENTION

The present invention relates to a system for controlling a motor vehicle, and particularly for operating the vehicle accelerator and brakes. This invention can be readily applied to vehicle control systems for physically impaired drivers.

A conventional motor vehicle, such as an automobile, is designed for a driver having full and substantially unrestricted use of all of their limbs. The standard vehicle controls include a rotary operating steering wheel, a depressible brake pedal, and a depressible accelerator pedal. Of course, it is known that the steering wheel is operated manually, while the brake and accelerator pedals are operated by the driver's feet. Current production vehicles assume that the driver has full use of his/her hands and feet in order to operate these vehicle controls.

Unfortunately, a significant percentage of the driving population does not have full use of all of their limbs. For instance, drivers with certain physical disabilities may be unable to use their legs to operate the brake and accelerator pedals. Although no production vehicles have been developed to account for physically-impaired drivers, a significant amount of effort has been expended in developing systems that can be integrated into an existing vehicle control system to accommodate this driving population. One such system is depicted and described in U.S. Pat. No. 4,722,416, which issued on Feb. 2, 1998 to one of the inventors of the present invention. A system embodying the teachings of the '416 patent has been sold by Ahnafield Corporation as its “Joystick Driving Control®” system.

The basic components of this system are shown in FIG. 1. In particular, a vehicle V, which includes a steering wheel S, a brake pedal B, and an accelerator pedal A, is provided with a braking/acceleration control system 10 that integrates with the vehicle controls. A joystick controller 12 is provided that can be manually manipulated by the physically-impaired driver. This joystick controller is link portioned to a control box 14 which carries an electronic circuit or microprocessor that produces control signals in response to movement of the joystick controller 12. These signals operate a brake control cylinder 16 or an accelerator control cylinder 18. These cylinders are part of a hydraulic system that can be actuated by signals from the control box 14 to depress or retract either of the two control pedals B, A. In certain applications, the joystick controller 12 can be a two-axis joystick, meaning that movement in one direction, say left or right, can be used to operate the steering in lieu of the steering wheel S, while movement in a perpendicular direction, such as forward and backwards, controls either the brake or accelerator pedal.

While the Joystick Driving Control® vehicle control system has been very successful in improving the freedom and mobility of the physically-impaired driver, there is always room for improvement. In particular, this system must be generally permanently installed in a vehicle. Thus, this system is not available for a physically impaired driver using a vehicle other than his/her own. For instance, a physically impaired driver cannot rent a car, at least until rental cars are equipped with driving control systems such as the Joystick Driving Control® vehicle control system. Thus, there remains a need for a vehicle control system for physically challenged drivers that is available for use with virtually any vehicle.

### SUMMARY OF THE INVENTION

To address this continuing need, the present invention provides a system for use by a physically impaired driver for controlling the braking and acceleration functions of a vehicle. In one embodiment, the system includes a pair of control rods that can be operated by the driver to directly depress the brake and accelerator pedals of a vehicle. The control rods include telescoping shafts that can be releasably locked at a length that is comfortable for the driver. The control rods are engaged to the vehicle pedals by way of a releasable strap with an attachment eye for receiving a hook at the end of the lowermost one of the telescoping shafts. The attachment eye extends from a pressure plate that facilitates even application of pressure to the vehicle pedal. A linking member links the upper end of the two control rods to form a stable construct while allowing each control rod to be independently manipulated.

In one aspect of the invention, a portable hand control apparatus is provided for use by a physically impaired driver of a vehicle that comprises a first rod assembly having a manually graspable handle at one end and an engagement member at an opposite end, a second rod assembly having a manually graspable handle at one end and an engagement member at an opposite end, a first mounting element having a mounting portion configured for removable mounting on the brake pedal of the vehicle and having an engagement portion configured for engagement with the engagement member of the first rod assembly, and a second mounting element having a mounting portion configured for removable mounting on the accelerator pedal of the vehicle and having an engagement portion configured for engagement with the engagement member of the first rod assembly. In the preferred embodiment, both of the first and second rod assemblies has an adjustable length.

In certain embodiments, the engagement member of at least one of the first and second rod assemblies includes a hook and at least one of the first and second mounting elements includes an eye for removable engagement by the hook. The mounting portion of at least one of the first and second mounting elements may include a mounting plate configured to sit on a corresponding one of the brake and accelerator pedal and at least one strap connected to the mounting plate and configured to encircle the pedal. Preferably, the strap includes a removable attachment surface between portions of the strap, such as hook and loop fasteners between the portions of the strap.

In a further feature of the invention, the apparatus further comprises a linking member linking an upper end of the first rod assembly to an upper end of the second rod assembly while permitting relative movement between the first and second rod assemblies along an axis of the rod assemblies. The linking member holds the relative positions of the two rod assemblies and helps form a stable construct. In one embodiment, the linking member includes a collar configured to be mounted on one of the first and second rod assemblies and a hook-shaped link extending from the collar and configured to slidably receive the other of the first and second rod assemblies through the hook shape of the link.

It is one object of the invention to provide a system that can be easily managed by a person having a physical disability that might otherwise prevent that person from operating a motor vehicle. One important object is to provide such a system that can provide that driver with the greatest ability to control the vehicle braking and acceleration.

A further object of the invention resides in features that make the system easily used with virtually any vehicle with as little disruption to the driver-side area of the vehicle. Yet another object is accomplished by features that ensure stable and reliable actuation of the vehicle pedals.

These and other objects, as well as many benefits of the present invention, will become apparent upon consideration of the following written description, taken together with the accompanying figures.

### DESCRIPTION OF THE FIGURES

FIG. 1 is a perspective view of one type of prior art vehicle control system.

FIG. 2 is a perspective view of a control rod assembly according to one embodiment of the present invention, shown engaged to the control pedals of a vehicle.

FIG. 3 is a view of the disassembled components of the control rod assembly shown in FIG. 2.

FIG. 4 is a top perspective view of the strap used for connecting the vehicle brake pedal to the control rod assembly shown in FIG. 2.

FIG. 5 is an enlarged top perspective view showing the control rod components connected to the strap mounted on each vehicle pedal.

FIG. 6 is a top perspective view of the control rod assembly in its operative position relative to the vehicle seat and pedals.

FIG. 7 is a pictorial view of the control rod assembly bundled for storage and transport.

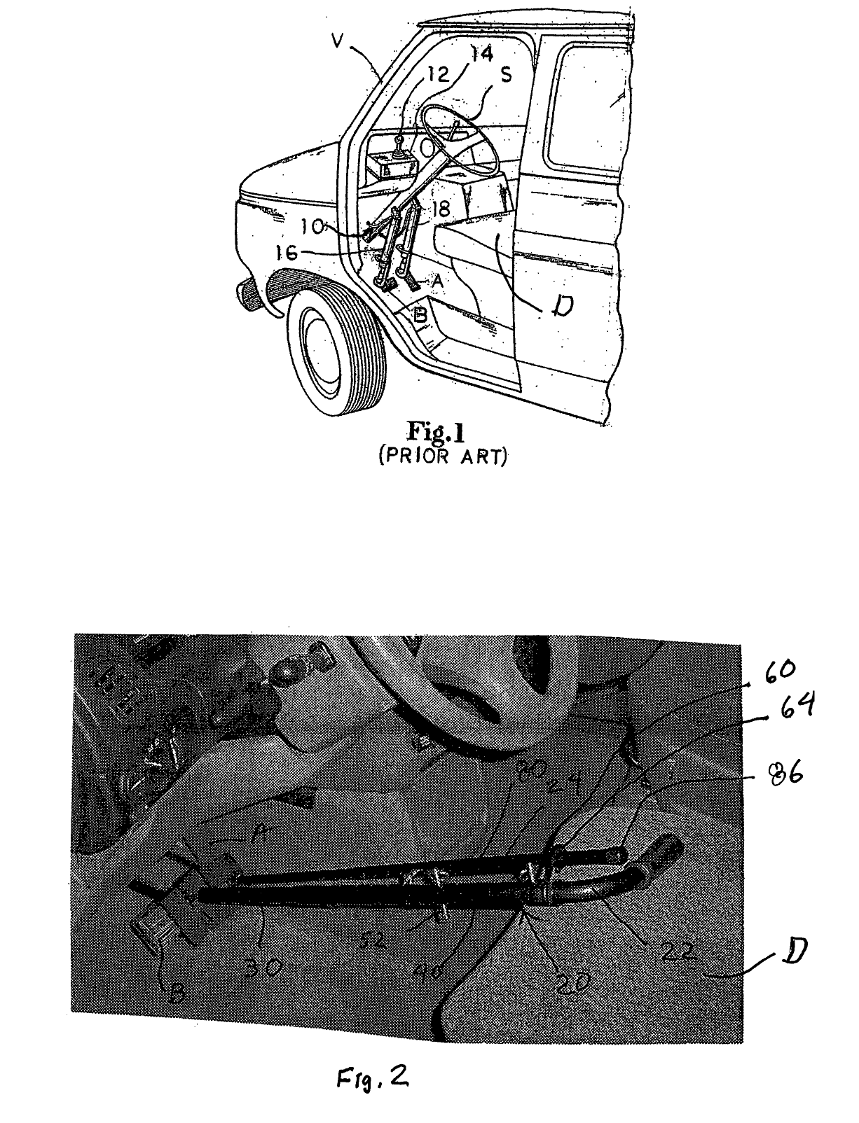

### DESCRIPTION OF THE PREFFERED EMBODIMENTS

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

The present invention contemplates a portable hand control system 20, as shown in FIG. 2, which allows a physically challenged driver to use virtually any vehicle. Specifically, the system provides a direct interface with the existing vehicle brake and accelerator pedals. The system 20 includes a pair of control rod assemblies 22 and 24, with the first control rod assembly 22 providing an interface to the brake pedal B and the second 24 controlling the accelerator pedal A, all while the operator is seated on the driver's seat D.

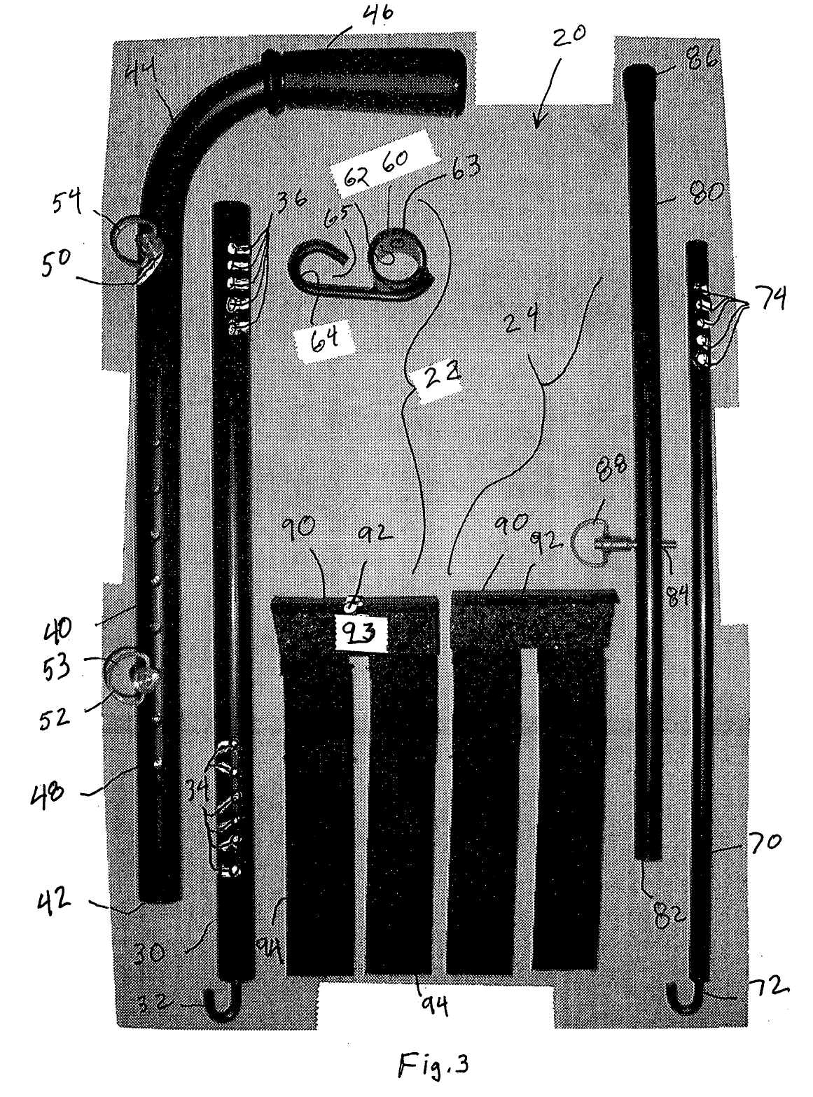

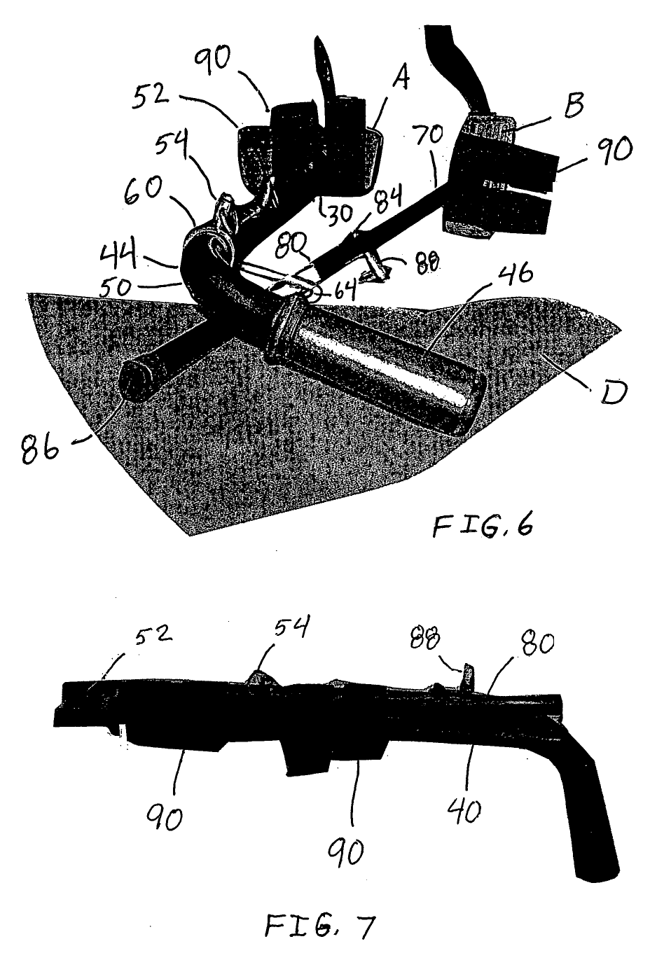

The components of the control rod assemblies are shown disassembled in FIG. 3. The first control rod assembly 22 is provided for engagement to the vehicle brake B (FIGS. 2, 6) and includes a lower rod 30 that terminates at one end in an engagement member 32. In the preferred embodiment, the engagement member 32 is a hook The lower rod can be hollow to reduce the weight and inertia of the rod. However, it is important that the rod have an acceptable wall thickness so that it does not buckle under extreme use conditions, such as emergency brake application. The lower rod 30 defines a plurality of lower thru holes 34 passing through the diameter of the rod and a plurality of similarly formed upper thru holes 36 at the upper end of the rod.

An upper rod 40 is provided that telescopically engages the lower rod 30. The upper rod is hollow from its open end 42 at least adjacent to a bend portion 44. The upper end of the rod 40 terminates in a handle 46 that is configured to be firmly and comfortably grasped by a vehicle operator. The handle can include a variety of hand hold and grip configurations, which may be interchangeable.

The upper rod 40 has an inner diameter slightly greater than the outer diameter of the lower rod 30 so the lower rod can be telescopically received within the hollow bore of the upper rod. The upper rod includes a plurality of thru holes 48 that extend through the entire diameter of the upper rod. In the preferred embodiment, these thru holes are formed at least half way up the length of the rod 40 toward the bend portion 44. A second thru hole 50 is provided adjacent the bend 44 for engagement with one of the plurality of holes 36 in the upper end of the lower rod.

As shown in FIGS. 2 and 6, the lower rod 30 is telescopically disposed within the upper rod 40. A locking pin 52 is provided for releasable engagement within aligned thru holes 34 and 48 between the telescoping rods. The locking pin 52 can be of conventional design that allows the pin to be easily inserted and removed only when the pin ring 53 is pulled. Of course, other types of locking configurations are contemplated that can extend through the aligned thru holes, such as a cotter pin component. As can be readily appreciated, the array of thru holes 34 and 48 allow the combined length of the two rods 30 and 40 to be adjusted. While one locking pin 52 is provided in the illustrated embodiment, additional locking pins can pass through other aligned thru holes 34, 48, or a U-shaped locking element can be utilized that simultaneously passes through two sets of aligned thru holes. The goal is to permit telescoping adjustability between the two rods 30, 40 and to solidly lock the two rods together.

A collar 60 is provided that can be fastened to the upper rod 40. The collar includes a tubular portion 62 that slides over the upper rod. The tubular portion includes a thru hole 63 of its own that is aligned with the upper thru hole 50 in the upper rod. A locking pin 54 is provided to lock the collar 60 to the upper rod of the rod assembly 22. One of the upper thru holes 36 of the lower rod 30 is also aligned so that the locking pin 54 extends through both rods 30, 40 as well as the collar 60. A link portion 64 extends from the collar 60 with the portion having a hook-shape that curves inwardly but leaves an opening 65 for reasons explained below.

The second rod assembly 24 is configured for engagement to the accelerator pedal A (FIG. 2) and also includes a lower rod 70 that terminates at one end in an attachment hook 72. This attachment hook can be configured similar to the hook 32 in the brake rod assembly 22. The upper portion of the lower rod 70 defines a plurality of thru holes 74 similar to the holes previously discussed. The rod assembly 24 also includes an upper rod 80 that defines a hollow interior from its lower end 82 and preferably throughout its entire length. The upper end of the rod can be capped with a gripping knob 86 that is grasped by the driver to depress the accelerator control rod assembly. Like the upper rod 40 of the brake control rod assembly 22, the upper rod 80 of the accelerator control rod assembly 24 also defines at least one thru hole 84 that can be aligned with holes 74 of the lower rod when the two rods are telescopically joined. A locking pin 88, similar to the pin 52, is used to hold the position of the lower and upper rods 70, 80.

Referring to FIGS. 2 and 6, the function of the collar 60 can be discerned. When the collar is engaged to the brake control rod assembly 22, the link portion 64 faces the accelerator control rod assembly 24. The upper rod 80 of that assembly is threaded into the link portion 64 through the opening 65. The link portion 64 loosely restrains the upper rod 80 of the accelerator control rod assembly so that the assembly can be manipulated independent of the brake control rod assembly. In other words, when the brake control rod assembly 22 is depressed, the accelerator rod assembly 24 will slide freely within the link portion 64, and vice versa when the accelerator rod assembly is depressed. This same relative motion is permitted when the return springs of the brake pedal B or the accelerator pedal A restores the respective pedal and engaged rod assembly to their neutral position.

The collar 60 helps keep the two control rod assemblies in close proximity to each other and to the driver when he/she is seated on the driver's seat D. More importantly, the collar 60 and link portion 64 prevent one of the control rods from becoming dislodged from its associated pedal when it is engaged in the manner described below. As best seen in FIG. 6, the collar and link portion form a bridge between the upper ends of the two control rods 50, 80 which works with the engagement of the lower ends to the respective brake and accelerator pedals to form a stable framework, even when the system 20 is pivoted away from the driver's seat D.

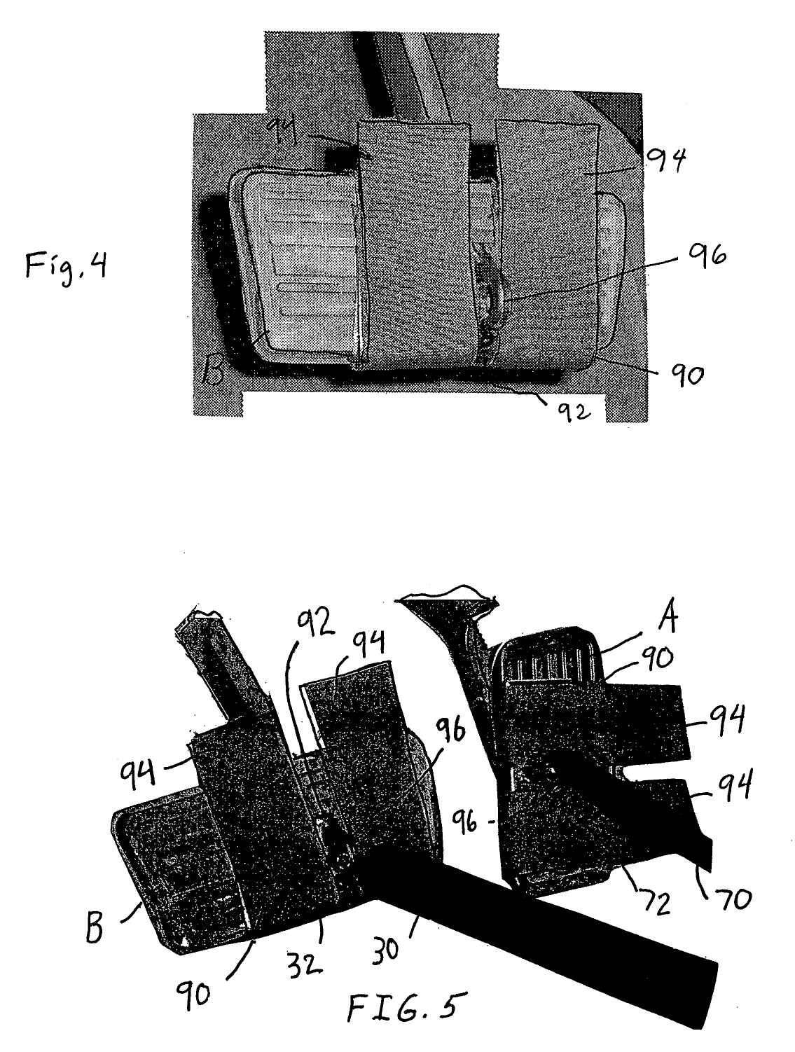

The hooks 32, 72 at the ends of the lower rods 30, 70 of each control rod assembly 22, 24 provides means for engagement of the control rod assemblies to the corresponding vehicle pedals A, B. As shown in FIGS. 3 and 6, each control rod assembly includes a removable mounting element 90 at its distal or lower end. Each mounting element includes a mounting plate 92 that is configured to bear against the vehicle pedal. In a preferred embodiment, the underside of the plate 92 can include a friction surface 93 to prevent slippage of the mounting plate on the pedal. Extending from the mounting plate are a pair of laterally offset straps 94. These straps are sized to wrap around one of the vehicle pedals. For instance, as shown in FIGS. 4 and 5, the two straps 94 wrap around the brake pedal B, and encircle the mounting plate 92 to hold it firmly on the brake pedal. The two straps include material that can releasably engage, such as hook and loop fastener material. In this way, the strap can be wrapped around the mounting plate and vehicle pedal and pressed together to hold the construction together.

The mounting plate includes a hook eye 96 that projects from the plate, as most clearly shown in FIG. 4. The hook eye projects upward from the brake pedal B through the space between the two straps 94. The hook eye 96 is configured to receive one of the hooks 32, 72 therethrough. The hooks and hook eye are dimensioned so that the hook can be readily inserted into the eye only by tilting the control rod assembly nearly parallel to the vehicle pedal. When the control rod assembly is tilted upright, the hook is firmly lodged within the hook eye and cannot be removed unless the rod assembly is again lowered. Since the collar 60 holds the two control rod assemblies together, albeit loosely, it prevents the rod assemblies from accidentally falling into a position in which one of the hooks 32, 72 can become dislodged from a corresponding hook eye 96.

As shown in FIG. 5, the straps for the two rod assemblies are preferably oriented at different angles. For instance, the mounting plate and straps affixed to the brake pedal B are arranged so that the opening of the hook eye 96 faces laterally. On the other hand, the mounting element 90 is attached to the accelerator pedal A so that the opening of the hook eye 96 faces vertically. Thus, it is necessary to manipulate the brake control rod assembly 22 differently to engage the hook 32 into the hook eye, than the manipulation required to engage the hook 72 of the accelerator control rod assembly 24. This feature provides an added degree of assurance that the rod assemblies won't become disconnected from their associated pedals.

When not in use, the components of the control system 20 shown in FIG. 3 can be easily bundled and held together by the mounting assemblies 90, as shown in FIG. 7. The upper and lower rods can be stacked together and the mounting assemblies wound around the aligned rods, making the assembly extremely portable. It should be appreciated that assembly and mounting of the control rods is relatively simple and does not require an inordinate amount of manipulation.

When it is desired to mount the control system 20 to a vehicle, several approaches can be taken. In a preferred approach, the mounting assemblies 90 are strapped to the brake and accelerator pedals with their corresponding hook eyes 96 oriented as shown in FIG. 5. The hook 32 of the lower rod 30 of the brake rod assembly 22 is then engaged to the brake pedal hook eye, and the same is done with the hook 72 of the lower rod 70 of the accelerator rod assembly 24. With the collar 60 threaded onto the rod 40, the upper rod 40 is threaded onto the lower rod 30 and the relative length of the telescoping rods is adjusted to meet the driver's preference. When the handle 46 of the upper rod 40 is comfortably positioned, the locking pin 52 is pushed through the aligned thru holes 34, 48 to lock the two rods together. The hole 63 of the collar 60 is aligned with the upper thru hole 50 with the link portion 64 facing the accelerator rod assembly 24. The locking pin 54 is passed through the holes 63, 50 and the corresponding aligned hole 36 in the upper end of the lower rod 30 to lock the collar in position. The handle 46 of the upper rod 40 can be oriented to the left or the right according to the operator's preference.

A similar process is undertaken with respect to the accelerator rod assembly 24. In particular, the upper rod 80 is threaded over the lower rod 70 is it is engaged to the accelerator pedal A, and the telescoping configuration is fixed by pushing the locking pin 88 through the aligned holes 84 and 74. As the upper rod is threaded over the lower rod, it is first passed through the opening 65 in the link portion 64 to fix the relative orientation of the two rod assemblies 22, 24. The complete assembly appears as shown in FIGS. 2 and 6 with the operating ends 46, 86 of the two rod assemblies 22, 24 readily accessible to the physically challenged driver when he/she is seated on the driver's seat D.

The rod assemblies 22, 24 are preferably formed of a strong metal, such as aircraft quality aluminum tubing. The tubing primarily endures force along its axis as the corresponding rods assemblies are pushed down to depress the brake or accelerator pedal. The telescopic nature of the two assemblies adds resistance to bending and buckling of the tubular material. In addition to its high strength, the preferred aluminum tubing material is lightweight so that the stowed assembly can be easily carried in a briefcase or carry-all bag. Each rod portion, 30, 40, 70 and 80 is preferably less than twenty inches in length with a maximum outer diameter of about one inch.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

1. A portable hand control apparatus for use by a physically impaired driver of a vehicle comprising:
a first rod assembly having a manually graspable handle at one end and an engagement member at an opposite end;
a second rod assembly having a manually graspable handle at one end and an engagement member at an opposite end;
a first mounting element having a mounting portion configured for removable mounting on the brake pedal of the vehicle and having an engagement portion configured for engagement with said engagement member of said first rod assembly; and
a second mounting element having a mounting portion configured for removable mounting on the accelerator pedal of the vehicle and having an engagement portion configured for engagement with said engagement member of said first rod assembly.

2. The portable hand control apparatus of claim 1, wherein at least one of said first and second rod assemblies has an adjustable length between said one end and said opposite end.

3. The portable hand control apparatus of claim 2, wherein both said first and second rod assemblies has an adjustable length.

4. The portable hand control apparatus of claim 2, wherein said at least one of said rod assemblies includes:
an upper rod including the manually graspable handle;
a lower rod including the engagement member; and
a telescoping engagement between said upper rod and said lower rod.

5. The portable hand control apparatus of claim 4, wherein:
at least one of said upper rod and said lower rod includes a plurality of thru holes;
the other of said upper rod and said lower rod includes at least one thru hole; and
said telescoping engagement includes a removable pin configured to extend through aligned ones of said plurality of thru holes and said at least one thru hole.

6. The portable hand control apparatus of claim 1, wherein:
said engagement member of at least one of said first and second rod assemblies includes a hook; and
at least one of said first and second mounting elements includes an eye for removable engagement by said hook.

7. The portable hand control apparatus of claim 1, wherein said mounting portion of at least one of said first and second mounting elements includes:
a mounting plate configured to sit on a corresponding one of the brake and accelerator pedal; and
at least one strap connected to said mounting plate and configured to encircle the pedal.

8. The portable hand control apparatus of claim 7, wherein said at least one strap includes a removable attachment surface between portions of said strap.

9. The portable hand control apparatus of claim 8, wherein said removable attachment surface includes hook and loop fasteners between portions of said strap.

10. The portable hand control apparatus of claim 1, further comprising a linking member linking an upper end of said first rod assembly to an upper end of said second rod assembly while permitting relative movement between said first and second rod assemblies along an axis of said rod assemblies.

11. The portable hand control apparatus of claim 10, wherein said linking member includes:
a collar configured to be mounted on one of said first and second rod assemblies; and
a hook-shaped link extending from said collar and configured to slidable receive the other of said first and second rod assemblies through said hook shape of said link.

12. The portable hand control apparatus of claim 11, wherein:
said one of said rod assemblies includes a thru hole adjacent said upper end thereof;
said collar defines a thru hole arranged for alignment with the thru hole in said one of said rod assemblies; and
a removable pin configured to extend through the thru holes.
